(19) United States
(12) Patent Application Publication
(10) Pub. No.: US 2008/0140472 A1
(43) Pub. Date: Jun. 12, 2008

(54) Method and Computer Program Product for Modeling an Organization

(76) Inventors: Dagan Gilat, Haifa (IL); Amit Fisher, Nesher (IL); Guy Rackham, New York, NY (US); Guy Sharon, Rehovot (IL)

Correspondence Address: Stephen C. Kaufman;IBM CORPORATION, Intellectual Property Law Dept., P.O. Box 218, Yorktown Heights, NY, 10598, US

(21) Appl. No.: 11/609,471

(22) Filed: Dec. 12, 2006

(51) Int. Cl. G06F 17/30

(52) U.S. Cl. 705/7

(57) ABSTRACT

A method and computer program product for modeling an organization, the method includes: defining a set of component business modeling (CBM) templates, each includes multiple components, wherein the set of CBM templates includes at least one first level CBM template, multiple second level CBM templates and multiple third level CBM templates; receiving a request to generate a CBM representation of a certain business; and allowing a user to utilize at least one CBM template to provide the CBM representation of the certain business.

### FIELD OF THE INVENTION

The present invention relates to methods and computer program products for modeling an organization.

### BACKGROUND OF THE INVENTION

Component business modeling (CBM) is technique for modeling an enterprise into non-overlapping and unique business components. CBM methodology can create a CBM map of essential ‘building blocks’ (business components) of an organization. The CBM map can fit within a single page.

Each business component includes the people, processes and technology needed by this business component to act as a standalone entity and deliver value to the organization.

TABLE 1 illustrates an exemplary prior art CBM map. It is noted that CBM maps can include multiple columns and different business components. For simplicity of explanation it is assumed that there are six columns. The CBM map of TABLE 1 includes six columns and three rows. The columns are titled “business administration” (BM), “new business development” (NBD), “relationship management” (RM), “services and sales” (S&S), “product fulfillment” (PF) and “financial control and accounting” FC&A. The rows are titled “direct”, “control” and “Execute”—. Each row and each column includes multiple business components.

The columns of the CBM map are created after an analysis of the functions and value chain of an organization. The rows are defined by management level. A top row of the CBM map represents all business components that set the overall strategy and direction for the organization. A middle row, represents the business components in the organization that translate those plans into actions, in addition to managing the day-to-day running of those activities. The bottom row contains the business components that actually execute the detailed activities and plans of an organization.

TABLE 1

| | BM | NBD | RM | S&S | PF | FC&A |
|---|---|---|---|---|---|---|
| Direct | BP | SP | AP | SLP | FP | PP |
| Control | BUT | SM | RM | SLM | FP | CR |
| | SA | PM | CA | | | |
| Execute | SAD | PD | CAD | S | PF | CA |
| | PAD | MC | | CD | DM | GL |
| | | | | CR | | |

Referring to table 1: BP=business planning, SP=sector planning, AP=account planning, SLP=sales planning, FP=fulfillment planning, PP=portfolio planning, BUT=business unit tracking, SA=staff appraisals, SM=sector management, PM=product management, RM=relationship management, CA=credit assessment, SLM=sales management, FP=fulfillment planning, CR=compliance reconciliation, SAD=staff administration, PAD=product administration, PD=product delivery, MC=marketing campaign, CAD=credit administration, S=sales, CD=customer dialogue, CR=contact routing, DM=document management, GL=general ledger.

The CBM map shows activities across lines of business, without the constrictions of geographies, internal silos or business units. The CBM lets the user to view an entire organization on a single page.

CBM methodology can also be used as an analytical tool for different types of analysis, such as aligning organizational capabilities and investments with strategy, build integrated business and technology roadmap to address key issues and pain points, showing overlapping/duplicate capabilities on both the business and technology levels and provide a clear path to reconcile and more.

When a CBM map is tailored to a certain business multiple business components that belong to that certain business are generated. CBM maps of different businesses are tailored by different CBM professionals. Each CBM professional can tailor a CBM map according to his experience.

There is a need to further increase the efficiency of CBM methodology.

### SUMMARY OF THE PRESENT INVENTION

A method for modeling an organization, the method includes: defining a set of component business modeling (CBM) templates, each includes multiple components, wherein the set of CBM templates includes at least one first level CBM template, multiple second level CBM templates and multiple third level CBM templates; receiving a request to generate a CBM representation of a certain business; and allowing a user to utilize at least one CBM template to provide the CBM representation of the certain business.

Conveniently, the allowing includes: allowing a user to select a CBM template out of the set of CBM templates; and allowing a user to selectively define business components of the selected CBM template such as to provide the CBM representation of the certain business.

Conveniently, the allowing includes presenting to a user business components out of multiple business components that belong to the set of multiple CBM templates.

Conveniently, the allowing includes presenting to a user multiple business components that belong to the set of CBM templates and modifying at least one business components in response to modification information provided to the user.

Conveniently, the defining includes defining at least one component relationship between at least one business component and at least one other business component.

Conveniently, the method includes: receiving information selecting a business component; and if the selected business component is associated by a relationship to another business component, providing the user an indication about the relationship.

Conveniently, the defining of a business component includes defining at least one business component entity that belongs to the business entity.

Conveniently, the defining includes indexing multiple business components that belong to the set of CBM templates by at least one type of business component entities.

Conveniently, the at least one type of business entities includes a resource required form providing the business component.

Conveniently, the at least one type of business entities includes a service provided by the business component.

Conveniently, the first level CBM template represents a group of businesses and a second level CBM template represents a sub-group of the group of businesses.

Conveniently, the utilizing includes searching for at least one business component that belongs to a second level CBM template that represents a first sub-group of businesses that includes the certain business.

Conveniently, the utilizing includes searching for at least one component that belongs to a second level CBM template that represents a second sub-group of businesses that is associated with a first sub-group of business that includes the certain business.

Conveniently, the method further includes generating a new second level CBM template if the certain business does not belong to any sub-group of classes represented by second level CBM templates.

Conveniently, the first level CBM template is a global CBM template while a second level CBM template is an industry CBM template or a sub-industry CBM template.

### BRIEF DESCRIPTION OF THE DRAWINGS

The present invention will be understood and appreciated more fully from the following detailed description taken in conjunction with the drawings in which:

FIG. 1 illustrates a computer and a storage unit, according to an embodiment of the invention; and

FIG. 2 is a flow chart of a method for modeling an organization, according to an embodiment of the invention;

FIG. 3 illustrates a process of selecting CBM template out of the set of CBM templates, according to an embodiment of the invention;

FIG. 4 illustrates a process of selectively defining business components, according to an embodiment of the invention; and

FIGS. 5-21 are various diagrams illustrating various connections between business components and business component entities in a UML format, according to an embodiment of the invention.

### DETAILED DESCRIPTION OF THE DRAWINGS

According to an embodiment of the invention a CBM repository is provided. The CBM repository is used for generating CBM maps for businesses.

A CBM repository includes multiple CBM templates of different levels, each template includes multiple business components. CBM maps and business components can be reused thus easing the preparation of a CBM map that represents a certain organization.

The CBM repository allows a CBM analyst to leverage CBM techniques by smart reuse of CBM assets, and to perform advance analysis of CBM entities.

Conveniently, the CBM repository includes a universal CBM template, multiple industry or sub-industry CBM templates and multiple business specific CBM templates. These templates can be CBM maps, thus the CBM repository can include a universal CBM map, multiple industry and/or sub-industry CBM maps and multiple business specific CBM maps. It is further noted that the industry CBM template and the sub-industry CBM template can be regarded as being of the same level, but this is not necessarily so.

It is noted that the CBM repository can include more (or less) than three template levels. It is further noted that the templates can differ from global, industry and business level CBM templates.

According to various embodiments of the invention business components of different levels are linked to each other. In addition a business components can include one or more business components entities. The CBM repository can allow to search business entities by multiple types of indexes, including business component entity based indexes.

The user will be able to define attributes for each CBM entity. The CBM repository will allow users to retrieve values of the default attributes, as well as the values of user defined attributes.

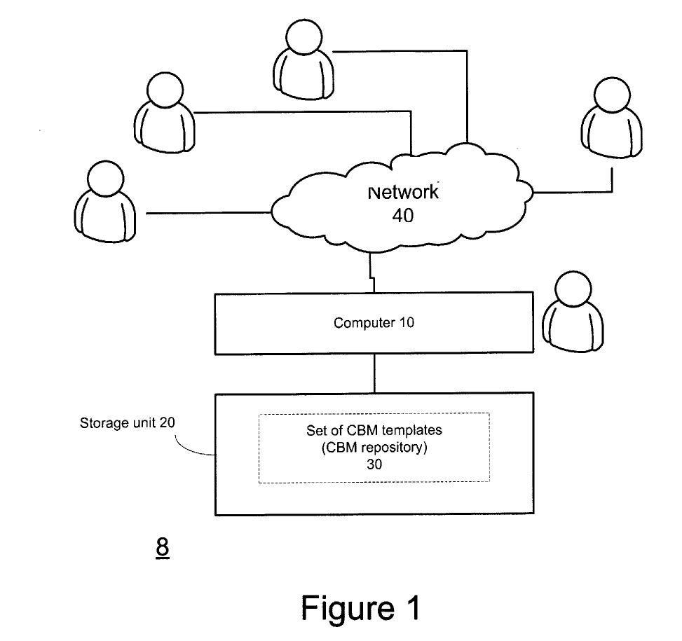

FIG. 1 illustrates an environment 8 according to an embodiment of the invention.

Environment 8 includes storage unit 20, processor and optional network 40.

Storage unit 20 stores a set of CBM templates 30 that can form a CBM repository. Computer 10 can access storage unit and retrieve CBM information. Users can utilize computer 10 for retrieving and information from storage unit 20. Users can also utilize computer 10 for sending information to storage unit 20.

According to an embodiment of the invention users (customers) are connected to computer 10 and additionally or alternatively to storage unit 20 via one or more networks, and they are able to receive a service over the one or more networks, such as network 40. Those of skill in the art will appreciate that the CBM repository can be stored in more than one storage unit and that multiple computers can be connected to one or more storage units. The storage unit 20 can also be a part of computer 10.

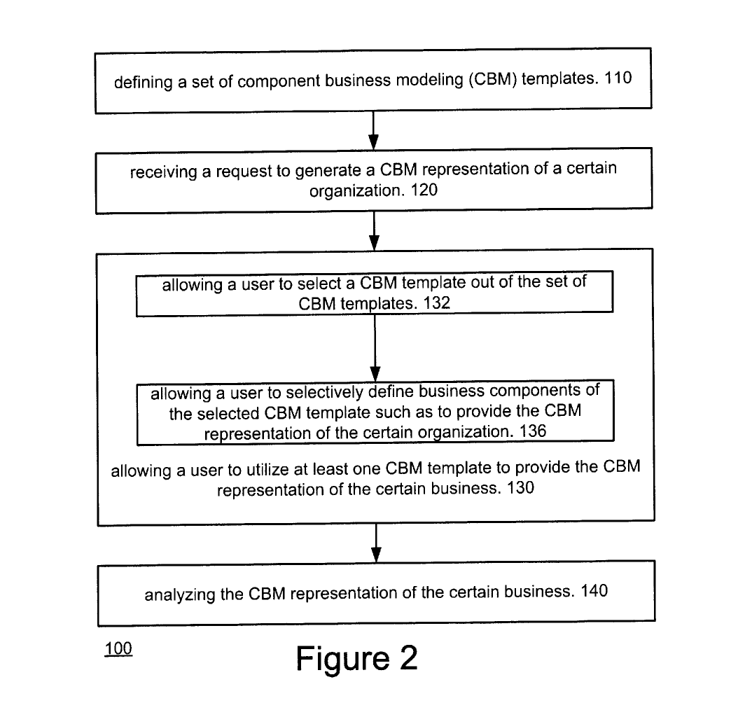

FIG. 2 is a flow chart of method 100 for modeling an organization, according to an embodiment of the invention.

Method 100 starts by stage 110 of defining a set of component business modeling (CBM) templates. Each CBM template includes multiple components. The set of CBM templates includes one or more first level CBM template, multiple second level CBM templates and multiple third level CBM templates. It is noted that the set of CBM templates can form a CBM repository.

Conveniently, the first level CBM template represents a group of businesses and a second level CBM template represents a sub-group of the group of businesses.

Conveniently the first level CBM template is a universal CBM template that can represents business from multiple industries. This first level CBM template can represent all known business known to the definer of the CBM repository, but this is not necessarily so. A second level CBM template is an industry CBM template or a sub-industry CBM template. A third level CBM template represents a single organization.

Stage 110 is followed by stage 120 of receiving a request to generate a CBM representation of a certain organization.

Stage 120 is followed by stage 130 of allowing a user to utilize at least one CBM template to provide the CBM representation of the certain business. Stage 130 can include: (i) providing access to the set of CBM templates or to a portion of that set, (i) receiving selection information and/or modification information from the user, and (iii) building a CBM representation of a certain organization.

Conveniently, stage 130 includes stage 132 of allowing a user to select a CBM template out of the set of CBM templates. Stage 132 is followed by stage 136 of allowing a user to selectively define business components of the selected CBM template such as to provide the CBM representation of the certain organization. The selected CBM template can be regarded as an initial CBM map.

The selection of the initial CBM map can fail and if this happens the user can receive a default CBM map. The default CBM map may be blank or include minimal information.

For simplicity of explanation it is assumed that the user wishes to generate a representation of a certain business that is referred to as business-x. Business_x belongs to sub-industry-x or to industry_x.

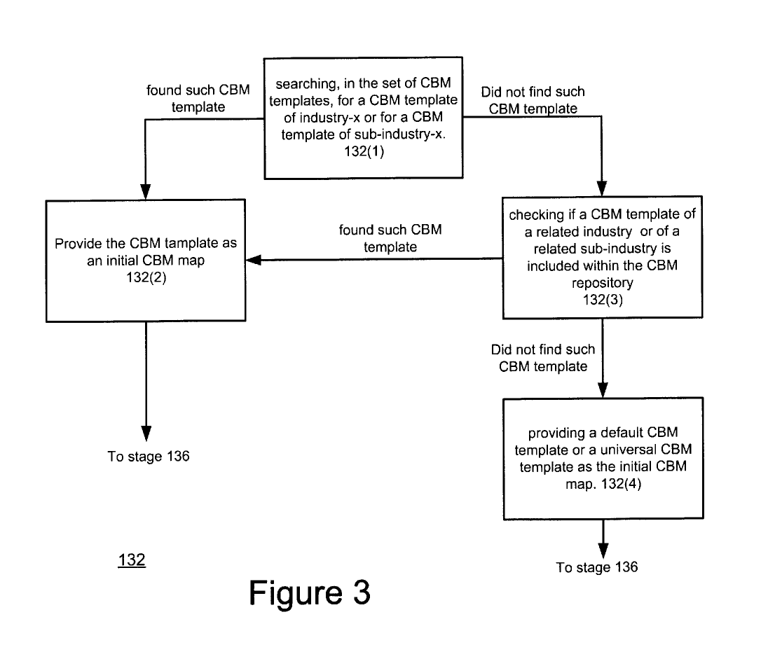

As illustrated by FIG. 3, stage 132 starts by stage 132(1) of searching, in the set of CBM templates, for a CBM template of industry-x or for a CBM template of sub-industry-x. The CBM repository may include the CBM template of industry-x, the CBM template of sub-industry-x, both CBM templates or none of these two CBM templates.

If the CBM repository includes at least one of said templates then stage 132(1) is followed by stage 132(2) of providing the found CBM template (of industry-x or of sub-industry-x) as the initial CBM map. Conveniently, if the CBM repository includes the CBM template of industry-x and the CBM template of sub-industry-x then the latter is selected.

If the CBM repository does not includes any of said two CBM templates then stage 132(1) is followed by stage 132(3) of checking if a CBM template of a related industry (related to industry-x) or of a related sub-industry (Related to sub-industry-x) is included within the CBM repository.

If the CBM repository includes at least one of said templates then stage 132(3) is followed by stage 132(2). Else, stage 132(3) is followed by stage 132(4) of providing a default CBM template or a universal CBM template as the initial CBM map.

Stages 132(2) and 132(4) are followed by stage 136 during which the user can start a CBM engagement.

Conveniently, stage 130 and especially stage 136 can include at least one of the following stages: (i) presenting to a user business components out of multiple business components that belong to the set of multiple CBM templates; (ii) presenting to a user multiple business components that belong to the set of CBM templates and modifying at least one business components in response to modification information provided to the user; (iii) defining one or more component relationship between one or more business component and one or more other business component.

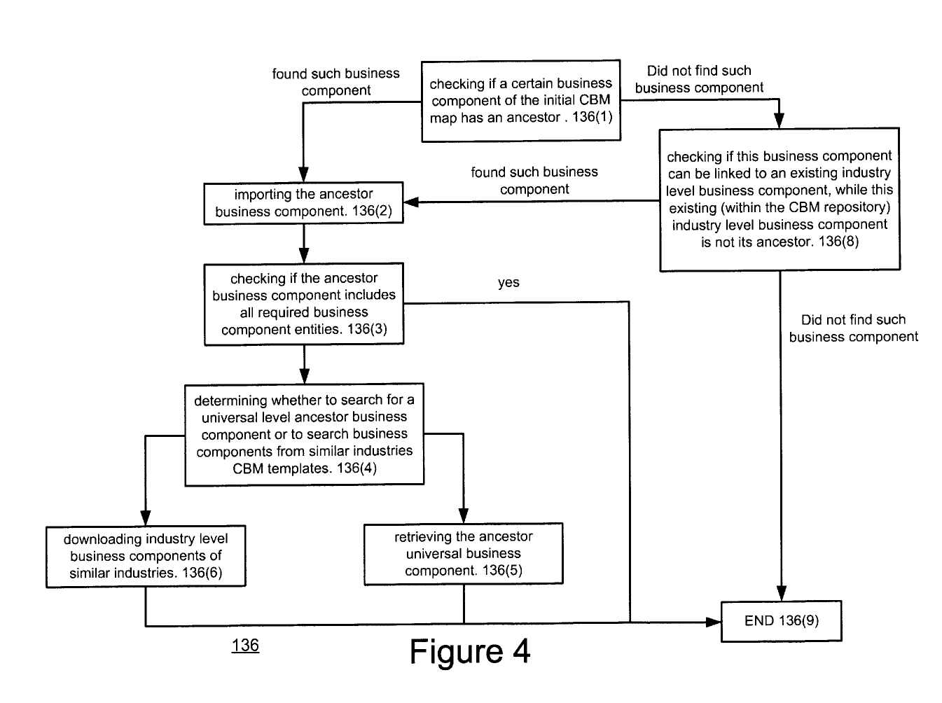

Referring to FIG. 4, stage 136 starts by stage 136(1) of checking if a certain business component of the initial CBM map has an ancestor—whether the CBM template of industry-x includes such a component.

If the answer is positive then stage 136(1) is followed by stage 136(2) of importing the ancestor business component.

If the answer is negative then stage 136(1) is followed by stage 136(8) of checking if this business component can be linked to an existing industry level business component, while this existing (within the CBM repository) industry level business component is not its ancestor.

If the answer is positive then stage 136(8) is followed by stage 136(2), else stage 136(8) is followed by stage 136(9).

Stage 136(2) is followed by stage 136(3) of checking if the ancestor business component includes all required business component entities. If the answer is positive then stage 136(3) is followed by stage 136(9).

Else (additional business components entities are required), stage 136(3) is followed by stage 136(4) of determining whether to search for a universal level ancestor business component or to search business components from similar industries CBM templates.

If the former is selected then stage 136(4) is followed by stage 136(5). Else, stage 136(4) is followed by stage 136(6).

Stage 136(5) includes retrieving the ancestor universal business component. Stage 136(6) includes downloading industry level business components of similar industries.

Stages 135(5) and 136(6) are followed by stage 136(9).

Stages 136(1)-136(6) provide an industry insight, as they allow to provide industry level information. It is noted that stage 136 can also include gaining a business level insight. Business level insight can includes stages 136(1), 136(8) and 136(2). In this case stages 136(8) and 136(2) are followed by stage 136(9).

Method 100 can provide information on business components that are associated with each other. Thus, is a first business component and a second business components are related to each other by a relationship that if a user wishes to see the first business component method 100 can also display (or provide another indication) about the second business components as well as the type of the relationship between the first and second business components. Accordingly, stage 130 includes: receiving information selecting a business component; and if the selected business component is associated by a relationship to another business component, providing the user an indication about the relationship.

Method 100 can include a stage of searching the set of CBM templates for information. This searching can be a part of stage 130 but this is not necessarily so. For example, various searches can be initiated during stage 140 of analyzing the CBM representation of the certain business. The searching may include performing any of the mentioned above searches.

The following searches provide an example of various searches that can be conducted on the CBM repository: (i) Business component features—for a given business component, the user can be provided with different features (applications, infrastructure or human) of the business component, and discover one or more supporting technology components that provide the technical support for the specified features. (ii) Search for neighbors—for a given business component, the user can be provided with all business components that use the services provided by a certain business component. Alternatively or additionally a user can be provided with business components that offer the service that a certain business component consumes.

(iii) Search for collaborating patterns—for a given business component, the user can be provided with all the collaboration patterns in which a certain business component participates. In addition, a user can be provided with a collaboration pattern in which a certain business component plays a specific collaborative role. In addition, a user can be provided with all collaboration patterns in which a set of certain business components participate. (iv) For a given action, a user can be provided with (a) All the business services it supports, (b) the possible implementation of the action—within a specific client engagement, within the industry or across industries. For each implementation, the consultants can retrieve its relative maturity with regards to different geographies, its technical qualification and its supporting technology components. (c) Its operational dependency with other actions in different collaborations. (v) Measures—for each CBM entity in the CBM repository, the user can be provided with its associated measures and measures values (such as KPIs, benchmarks etc.). Alternatively or additionally a user can be provided with all CBM entities that are associated with the measures (i.e. all aspects of the CBM data model that influence the same measure). (vi) For a given technology component, a user can search its supported business components, and the associated business component features it supports. (vii) For a given physical realization of a business component, the user can retrieve its physical realizations, with the associated configuration (cloned, shared, compliant). (viii) For a given attribution criteria of a given business component, the user can search for associated attribution or search for all business components that are associated with a specific attribution value. (ix) For a given business entity—a user can search for business entities (clients), its strategic capabilities and its related projects (client engagements). For each project, the set of CBM templates can provide access to client data, and its associated CBM artifacts (CBM project deliverables). (x) For each CBM entity author, the user can search for the different CBM entities the author wrote, In addition tracking after different versions of the CBM can be facilitates by saving different versions of CBM entities as saving CBM entity version identification information.

Conveniently stage 110 includes defining at least one business component entity that belongs to the business entity. The business entity can include, for example, services provided by a business entity, services consumed by the business entity, technology (or other resources) required for maintain the business component and the like.

Conveniently, stage 110 includes indexing multiple business components that belong to the set of CBM templates by at least one type of business component entities.

Business components of the CBM repository can indexed by business components entities such as but not limited to: (i) a resource required for providing the business component; (ii) a service provided by the business component, (iii) a service required by the business component. The indexing facilitates multiple types of searches, some being indicated above.

It is noted that when a CBM representation of a certain business is generated the user can search higher level CBM templates in order to get business components that belong to the higher level CBM templates. For example, a user can select a certain CBM template and then search for business components that belong to industry level CBM templates, sub-industry level CBM templates, universal CBM templates and the like. Assuming that the user is generating a CBM representation of a certain business that belongs to a certain industry then method 100 can provide to the user business components that belong to CBM templates of the certain industry, of other industries, of other sub-industries and even to other lower level CBM templates.

Accordingly, stage 130 can include searching for at least one business component that belongs to a second level CBM template that represents a first sub-group of businesses that includes the certain business.

Alternatively or additionally, stage 130 can include searching for at least one component that belongs to a second level CBM template that represents a second sub-group of businesses that is associated with a first sub-group of business that includes the certain business.

According to an embodiment of the invention new CBM templates can be generated. It may include, for example, generating new second level templates. For example, if method 100 is used for generating a CBM map of a new business that belongs to a new (not represented yet) industry than the representation of the new business can be defined as a new higher-level CBM template. Accordingly, method 100 can include generating a new second level CBM template if the certain business does not belong to any sub-group of classes represented by second level CBM templates.

According to yet another embodiment of the invention second or third level business templates can be updated in response to newly generated CBM representation of a certain business.

It is noted that business components can collaborate with each other via collaboration patterns. CBM templates can also include collaboration patterns. These collaboration patterns can be fetches and later be used for various purposes. One purpose can include finding collaboration pattern in the same industry, in other industries in order to explore the development of such collaboration patterns in the business that is being evaluated by the user.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The inventor used a UML language to represent business components and business component entities. UML can represent a model by diagrams that are called class diagrams. A class diagram illustrates classes within a model. In an object oriented application classes have attributes (member variable), operations (member functions) and relationships with other classes. A class is represented by a class icon that includes the name of the class, one or more attributes and one or more operations. Not each icon includes attributes or operations. Various relationships between classes are illustrated by arrows that link related classes.

In UML representation, a business component is illustrated by a business component class. Relationships are illustrated by relationship classes, business components entities are represented by business components entity classes and the like.

The following table illustrates some of the classes used by the inventors, as well as their attributes. The amount of rows that illustrates business components is relatively small in relation to the rows that describe business component entities or properties (characteristics) of business components and business component entities.

TABLE 2

| Class | Attributes | Remark |
|---|---|---|
| Business action | Business | Business action is |
| | component, | a general term of |
| | business service, | expressing how |
| | maturity level, | services are |
| | name | implemented. |
| | | Maturity level can |
| | | be base, |
| | | competitive or |
| | | differentiator |
| Business component | Accountability/management | Management level |
| | level, | can include |
| | business action, | administer |
| | business component | (executing), assess |
| | feature, | (directing, |
| | description, | authorizer |
| | interaction (with | (controlling), |
| | provider), | budget (directing), |
| | interaction (with | create/make |
| | supplier), name, | (executive), |
| | offered business | maintain |
| | service, required | (executing), |
| | business service, | operate |
| | role, specialized | (executing), plan |
| | technology | (directing), policy |
| | component, utility | (directing), |
| | technology | schedule |
| | component | (directing) and |
| | | troubleshoot |
| | | (controlling). |
| Business action | Baseline maturity, | Expansion of the |
| implementation | business action, | action, |
| | description, | |
| | technology | |
| | qualification | |
| Business | Business | |
| competency | competency | |
| | strategic | |
| | capability, name, | |
| | representative | |
| | business component | |
| Business component | Specialized | Features that a |
| application | application | component expects |
| feature | supporting | to get from |
| | component, utility | application |
| | application | technology |
| | supporting | component that will |
| | component | support it |
| Business component | Business | |
| feature | component, | |
| | description, name | |
| Business component | | Features that a |
| human features | | component expects |
| | | to get from users |
| | | that will |
| | | execute/perform it |
| Business component | Specialized | Features that a |
| infrastructure | infrastructure | component expects |
| feature | supporting | to get from an |
| | component, utility | infrastructure |
| | infrastructure | component that |
| | supporting | supports it |
| | component | |
| Business entity | Business entity | |
| | ancestor, | |
| | business entity | |
| | capability, | |
| | business entity | |
| | descendent, | |
| | business entity | |
| | project, | |
| | description, name | |
| Business entity | Business entity, | |
| capability, | description | |
| Business entity | Business entity, | |
| project | business entity | |
| | project client | |
| | data, CBM | |
| | artifact, | |
| | description, name, | |
| | type | |
| Business entity | Business entity | |
| project client | project, CBM | |
| data, | artifact | |
| Business entity | BTO, CBM insight | |
| project types | project, | |
| | downstream | |
| | project, SO | |
| Business map | Description, | |
| | version | |
| Business service | Business action, | Business service |
| | consumer business | type can include |
| | component, | managing, |
| | description, | supporting or |
| | interaction, name, | transactional |
| | provider business | |
| | component, type, | |
| | utility data | |
| | service component | |
| CBM author | CBM entity, | |
| | contact | |
| | information, name | |
| CBM entity | CBM entity author, | |
| | identity, measure, | |
| | measure name | |
| CBM project | Business entity | Any deliverable |
| artifact | project, business | from a CBM project |
| | entity client data | |
| Client business | Client business | |
| competency | component, client | |
| | map, industrial | |
| | business | |
| | competency | |
| Client business | Ancestor industry | |
| component | business | |
| | component, client | |
| | business | |
| | competency | |
| Client map | Client business | |
| | competency, name | |
| Collaboration | Collaboration | Role can be |
| pattern | pattern, extend, | analyzer, |
| | interaction, role | consolidator, |
| | | server, controller, |
| | | gatekeeper, |
| | | processor |
| Collaborative role | Business | Represents a |
| | component, | collaborative role |
| | collaboration | a business plays in |
| | pattern, value | a specific |
| | | collaboration |
| Deployed solution | Description | Reason for adopting |
| insight | | a certain |
| | | configuration or |
| | | why there is a need |
| | | to customize |
| Geographic country | Country name, | |
| | geographic region | |
| Geographic country | Country name, | Maturity level of |
| relative maturity | geographic region | business in the |
| level | | country |
| Geographic region | Country name, | |
| | geographic region | |
| Industrial | Client business | |
| business | component, | |
| competency | industry business | |
| | component, | |
| | industry map, | |
| | universal managing | |
| | concept | |
| Industry business | Ancestor industry | |
| component | business | |
| | component, | |
| | ancestor universal | |
| | business | |
| | component, derived | |
| | client business | |
| | component, | |
| | industrial | |
| | business | |
| | competency, | |
| | representative | |
| | business | |
| | component, sub- | |
| | industry business | |
| | component | |
| Industry map | Industrial | |
| | business | |
| | competency, name | |
| Interaction | Collaboration | Interaction between |
| | pattern, | two business |
| | description, | components on a |
| | interaction | single service |
| | business service, | |
| | service provider, | |
| | service requester | |
| Keyhold | | How several |
| | | business components |
| | | are combined to |
| | | represent separate |
| | | legal entity or |
| | | organization that |
| | | does not appear in |
| | | detail in the CBM |
| | | map |
| Managing concept | Universal managing | |
| strategic | concept | |
| capability | | |
| Measure | 1% sensitivity | |
| | analysis | |
| | attributes, CBM | |
| | entity, | |
| | description, ID, | |
| | information | |
| | source, measure, | |
| | measurement | |
| | algorithm, name, | |
| | objective/ | |
| | purpose, | |
| | referenced | |
| | measure, | |
| | referencing | |
| | measure, update | |
| | date | |
| Measure value | CBM entity, | |
| | measure type, | |
| | multiple dimension | |
| | measure values, | |
| | value | |
| Multiple choice | Multiple choice | |
| measure type | measure type, | |
| permitted value | value | |
| Multiple choice | Multiple choice | |
| attribution | measure type | |
| criteria | permitted values | |
| Multiple choice | Multiple choice | |
| measure type | attribution | |
| permitted values | criteria, value | |
| Multiple choice | Default value, | |
| measure | multiple choice | |
| | measure type | |
| | permitted values, | |
| | value data type | |
| Multiple choice | Multiple choice | User defined |
| UDA | UDA permitted | attribute where its |
| | value | value is selected |
| | | from a finite set |
| | | of permitted values |
| Multiple choice | Multiple choice | |
| UDA permitted | UDA, value | |
| values | | |
| Multiple dimension | Measure value, | |
| measure attribute | multiple dimension | |
| value | values, value | |
| Multiple | Multiple dimension | |
| dimensions measure | values | |
| Multiple | Data type, default | |
| dimensions measure | value, | |
| attribute | description, | |
| | multiple dimension | |
| | measure values, | |
| | multiple | |
| | dimensions measure | |
| | type, name | |
| Numeric range | High value, low | |
| attribution | value | |
| criteria | | |
| Numeric range | Default value, | |
| measure | high value, low | |
| | value, value data | |
| | type | |
| Numeric range | High value, low | |
| UDA | value | |
| Dependency | Description of | Dependency between |
| | dependency, type | two actions in |
| | | relation to their |
| | | start or their |
| | | completion. There |
| | | are four |
| | | dependencies: |
| | | start-start, start- |
| | | finish, finish- |
| | | start, finish- |
| | | finish |
| Physical | Description, name | Physical |
| realization | | implementation of a |
| | | component. In can |
| | | be cloned (common |
| | | solution, multiple |
| | | deployments), |
| | | shared (single |
| | | solution, used by |
| | | all), or compliant |
| | | (common external |
| | | services, different |
| | | specific internals) |
| Qualification | Description, | Type can be |
| | maturity level, | operational or |
| | name, type | technology |
| Representative | Accountability | |
| business component | level, business | |
| | competency, client | |
| | business | |
| | component, | |
| | industry business | |
| | component | |
| Simple value | Default value, | |
| measure | value data type | |
| Specialized | Business component | |
| application | application | |
| component | feature | |
| Specialized | Business component | |
| infrastructure | | |
| component | | |
| Strategic | Description, name | Strategic |
| capability | | capability of |
| | | managing |
| | | concept/business |
| | | competency |
| Technology | Description, name | |
| component | | |
| Universal business | Derived industry | |
| component | business | |
| | component, | |
| | management level | |
| | sub type, | |
| | universal managing | |
| | concept | |
| Universal managing | Business area, | |
| concept | industrial | |
| | business | |
| | competency, | |
| | keywords, name, | |
| | strategic | |
| | capability, | |
| | universal business | |
| | component, | |
| | universal map | |
| Universal map | Universal managing | |
| | concept | |
| User defined | Type data, default | |
| attribute type | value, | |
| | description, | |
| | identification, | |
| | name | |
| Utility | Business component | |
| application | application | |
| component | feature | |
| Utility data | Supported business | |
| service component | service | |
| Utility | Business component | |
| infrastructure | infrastructure | |
| component | features | |
| Utility technology | Business component | |
| component | | |
| 1% sensitivity | 1% movement, 1% | Category can be |
| analysis | sensitivity | business |
| | analysis | performance, cost, |
| | attributes, | enumeration level, |
| | category | revenue, risk |
| | | analysis. |
| 1% sensitivity | 1% sensitivity | |
| analysis | analysis, | |
| attributes | description | |
| | measure, name | |

The inventors used various UML class diagrams to represent various relationships/links between different business component, business component entities and the like.

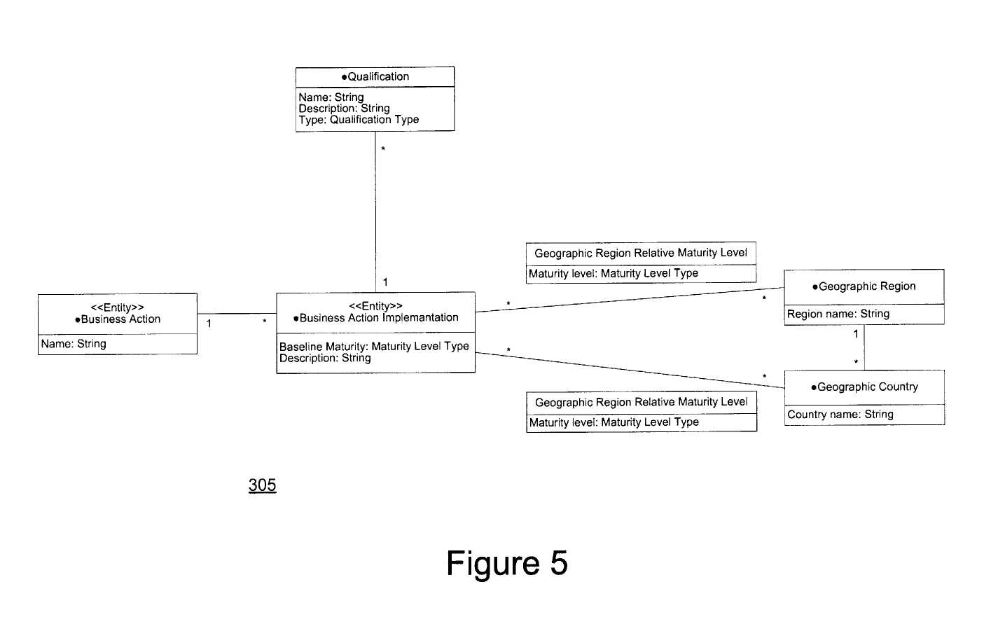

FIGS. 5-21 are various diagrams illustrating carious connections between business components and business component entities in a UML formal, according to various embodiments of the invention.

FIG. 5 is an action specialization diagram 305 that illustrates how an action is implemented in different maturity level (with or without geography scope) and its possible qualification.

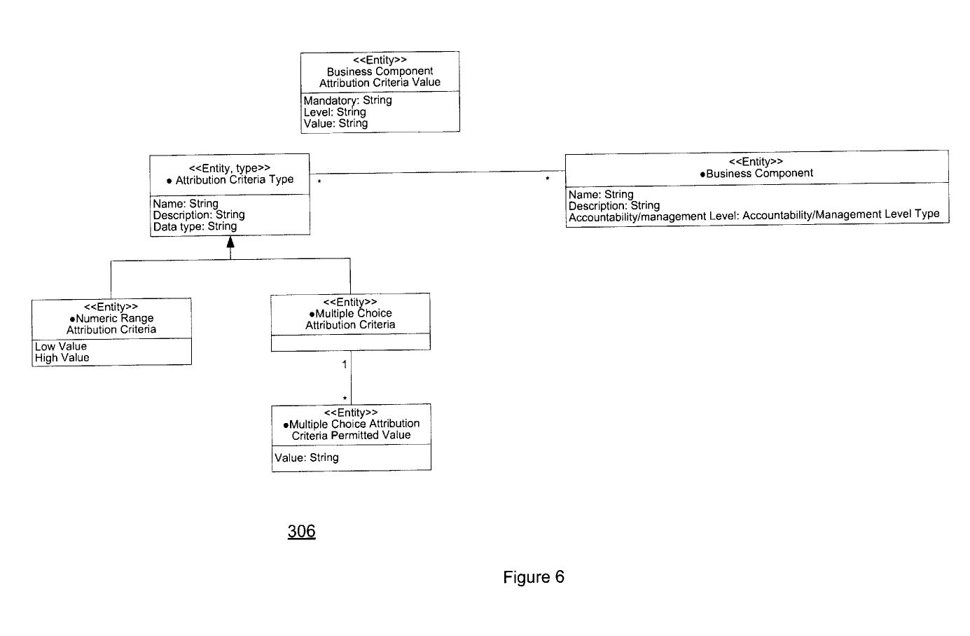

FIG. 6 is an attribution criteria diagram 306 illustrating how attributes can be applied to a component.

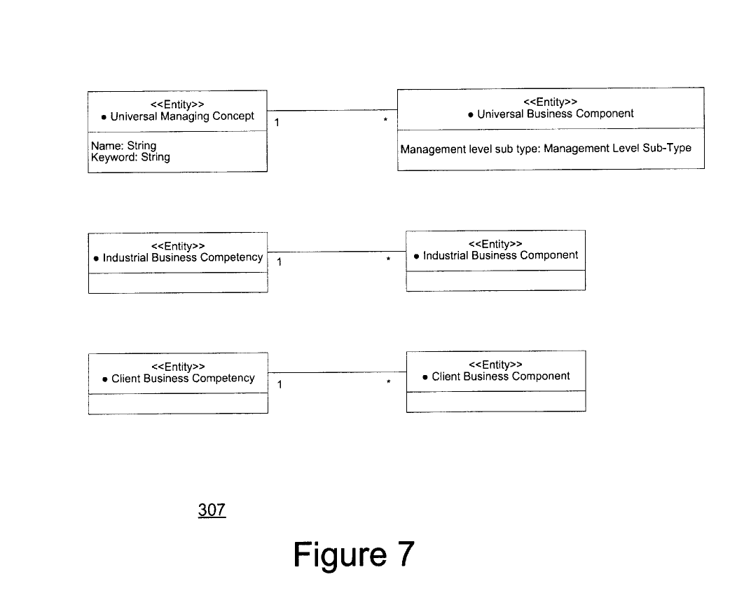

FIG. 7 is a business competencies—business component diagram 307 that illustrates relationships between business components and their managing concept/competencies.

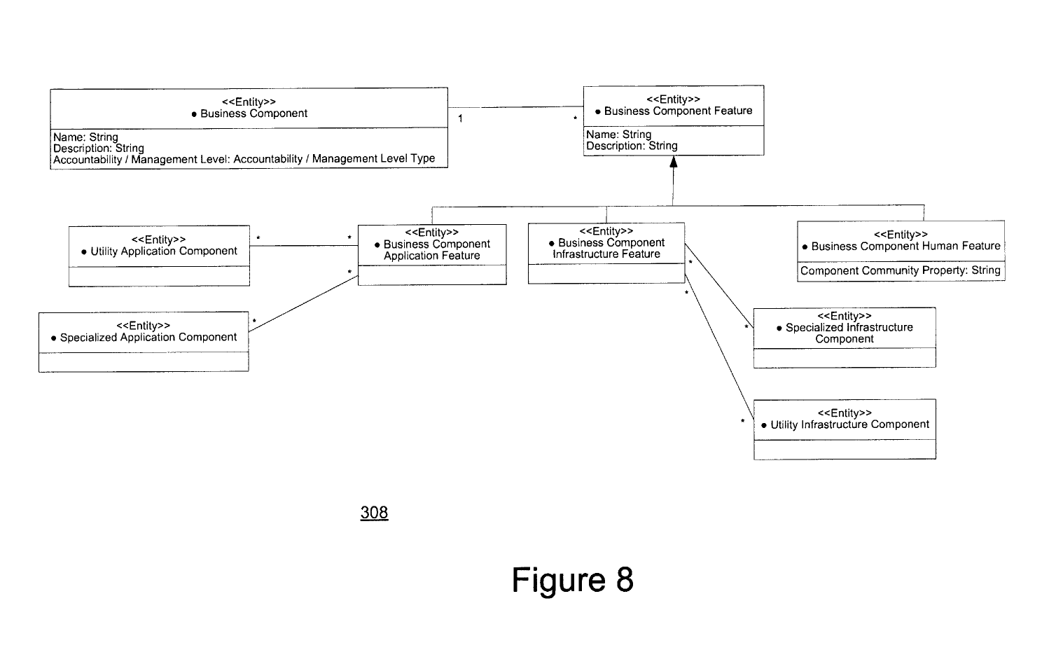

FIG. 8 is a business component feature diagram 309.

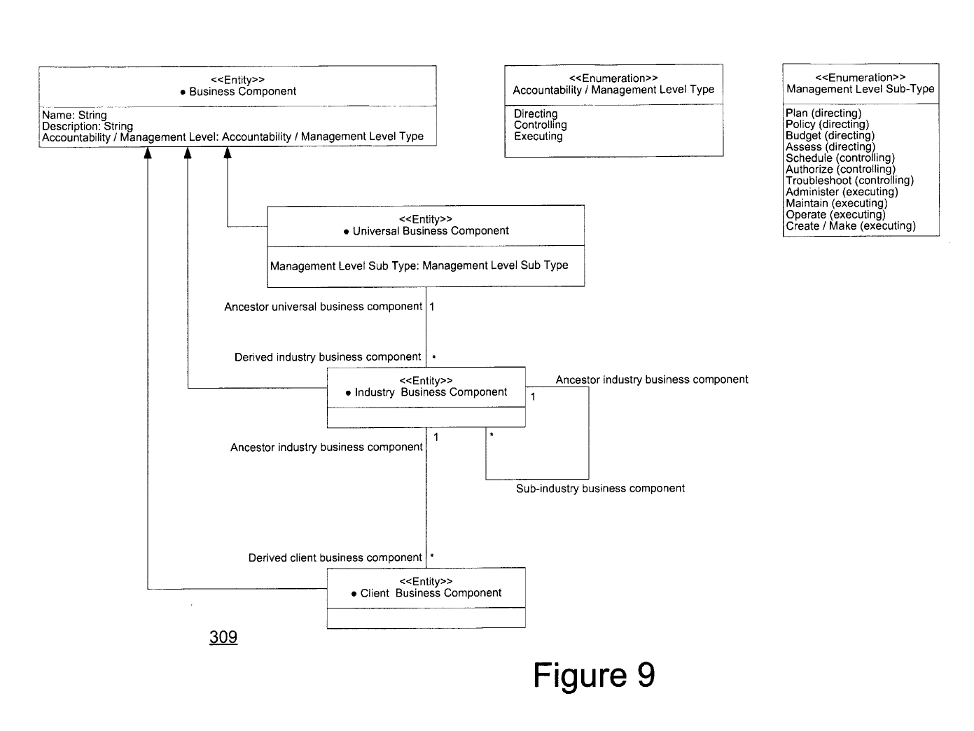

FIG. 9 is a business component diagram 309.

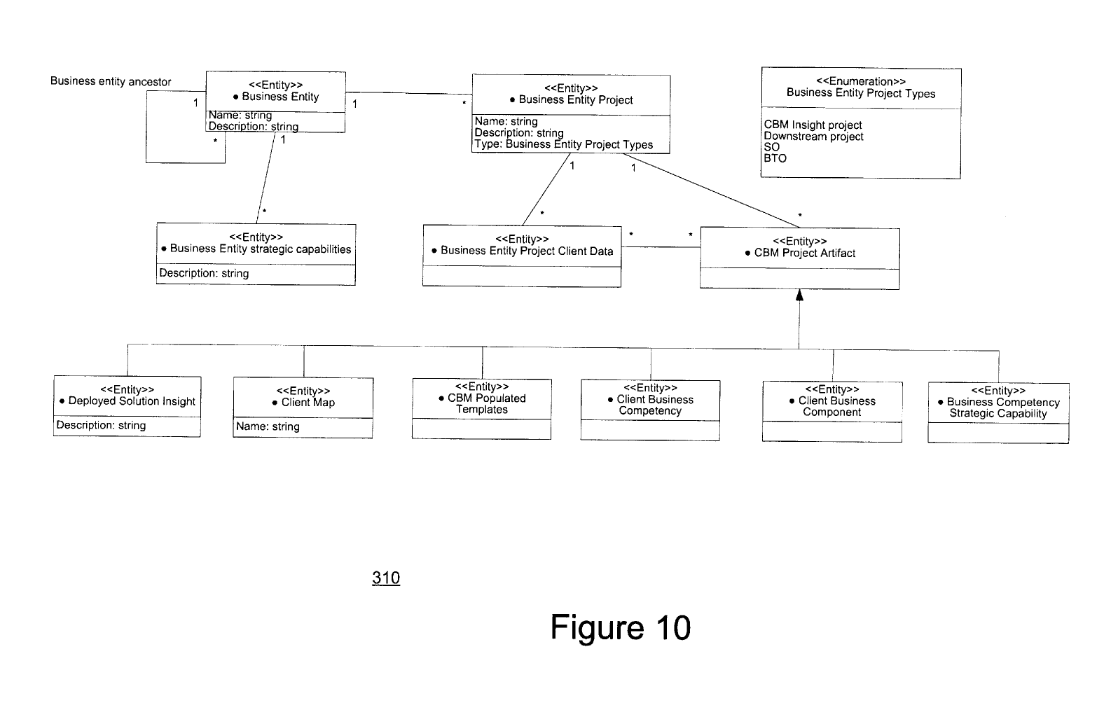

FIG. 10 is a business entity diagram 310 that illustrates a business component entity and its project artifacts.

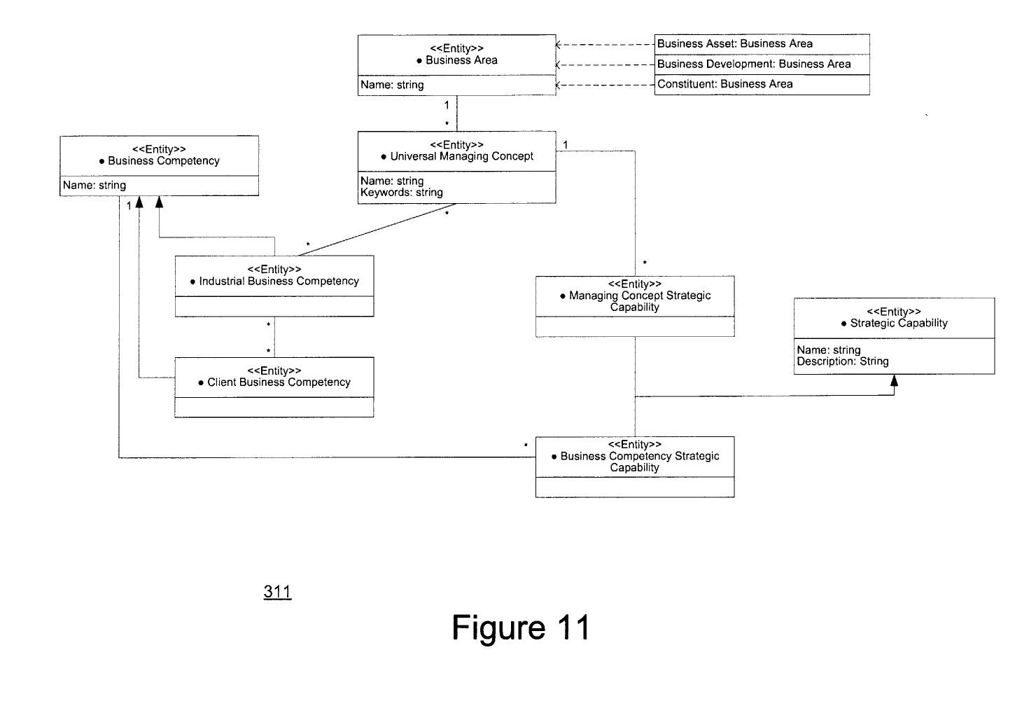

FIG. 11 is a business managing concepts and competencies diagram 311 that illustrates the relationship between managing concept and competencies.

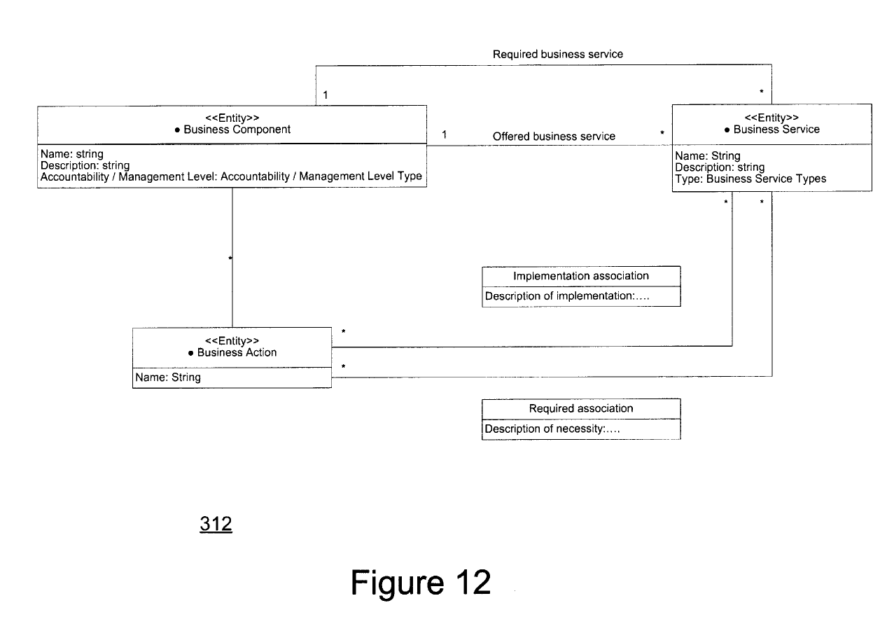

FIG. 12 is a business service and action diagram 312 that illustrates the relationship between a component its actions are services.

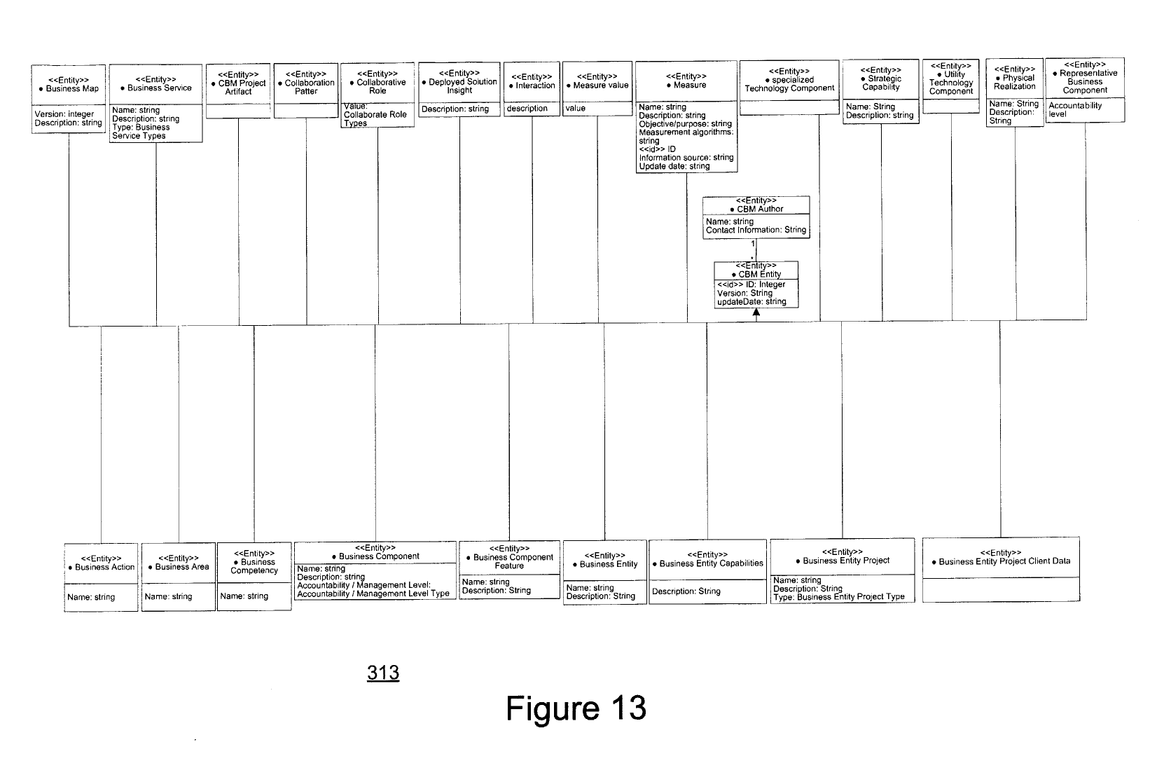

FIG. 13 is a CBM entity diagram 313 that illustrates different CBM entities in the model.

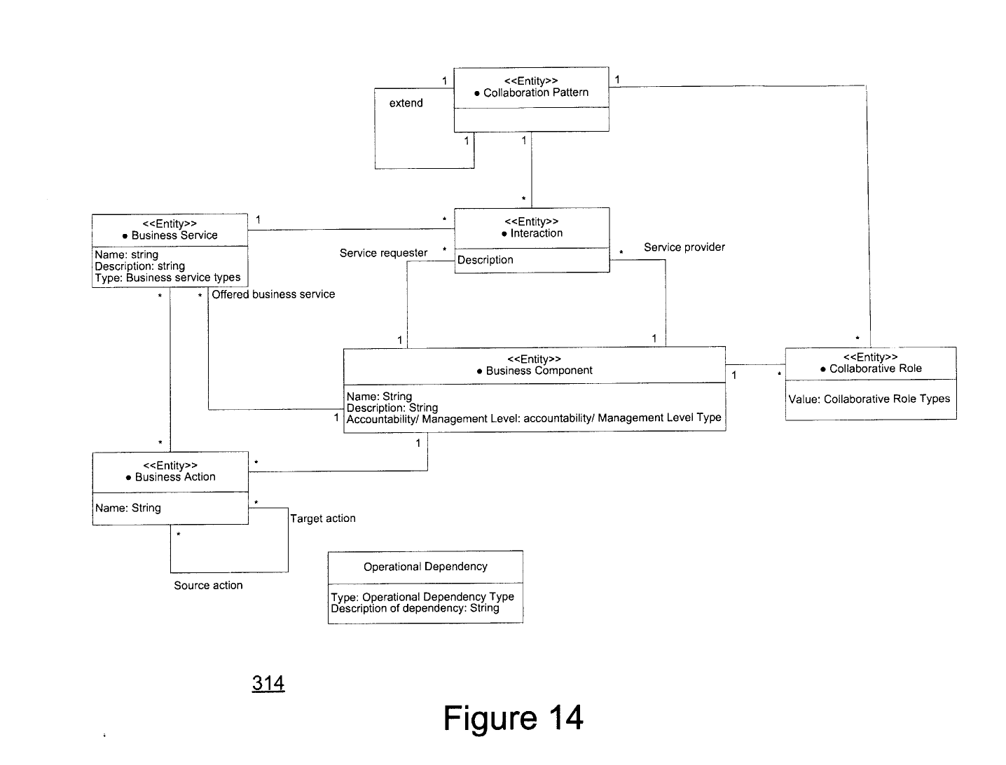

FIG. 14 illustrates a meta-model 314 for dynamic CBM analysis. Dynamic CBM analysis enables to re-evaluate various aspects of the model.

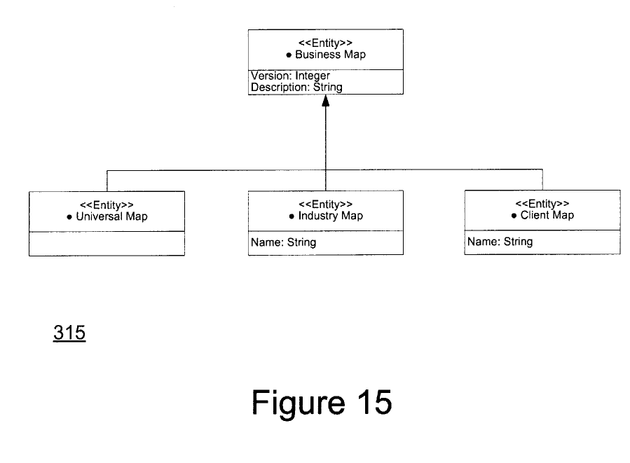

FIG. 15 is a map diagram 315 that illustrates the relationship between a certain CBM map and multiple level CBM maps.

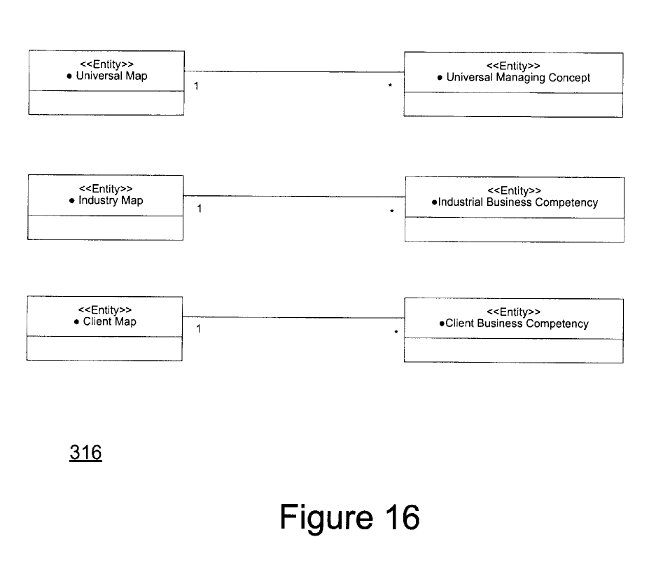

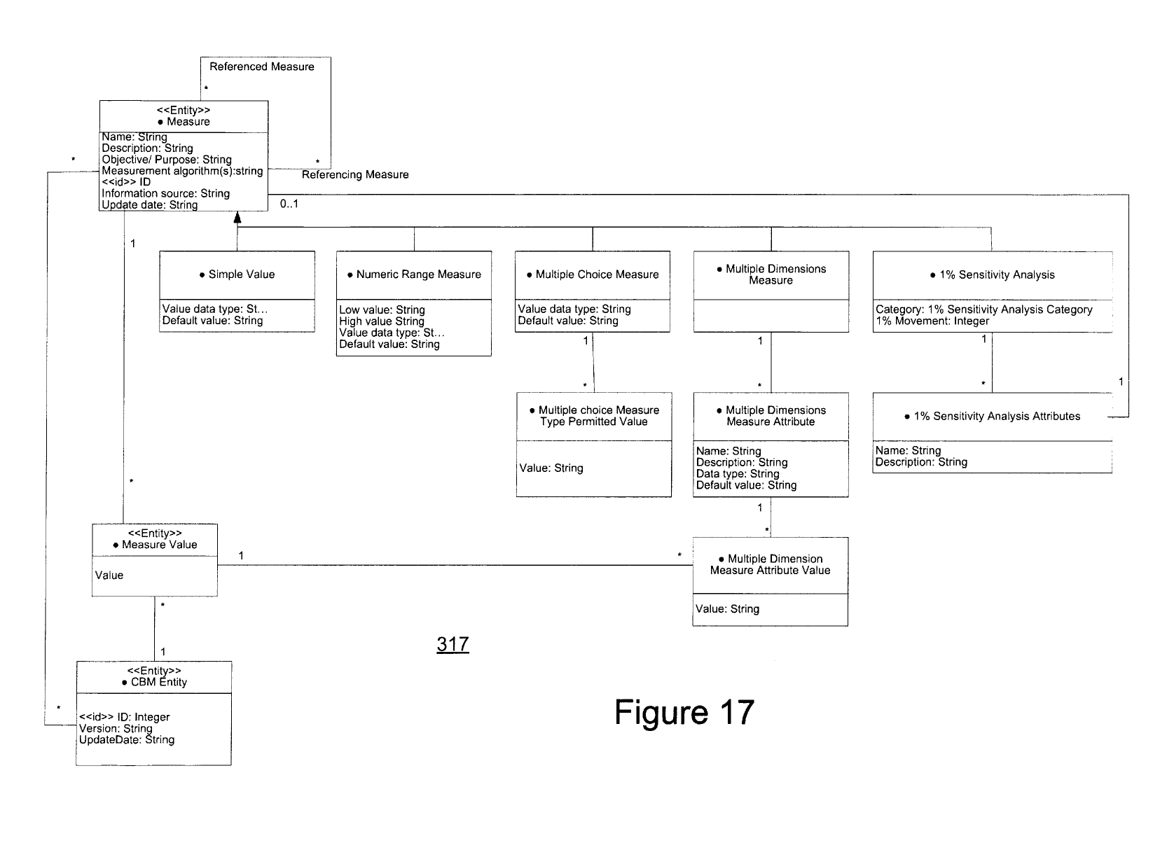

FIG. 16 is a maps business competencies diagram 316 that illustrates the relationships between CBM maps and corresponding concepts/business competencies. FIG. 17 is a measures/benchmark diagram 317 that illustrates a general framework for attributing measures to selected CBM entities.

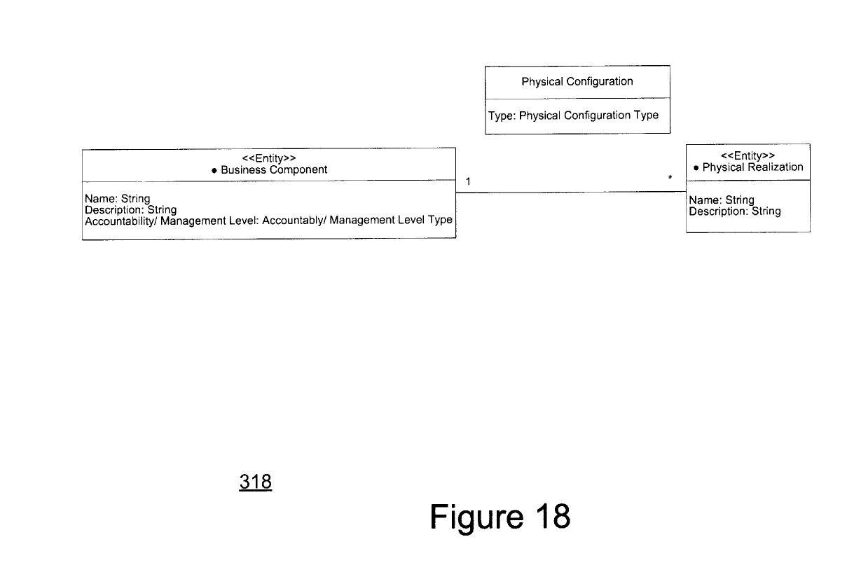

FIG. 18 is a physical realization of business component diagram 318 that illustrates the relationship between a business component and its physical realization.

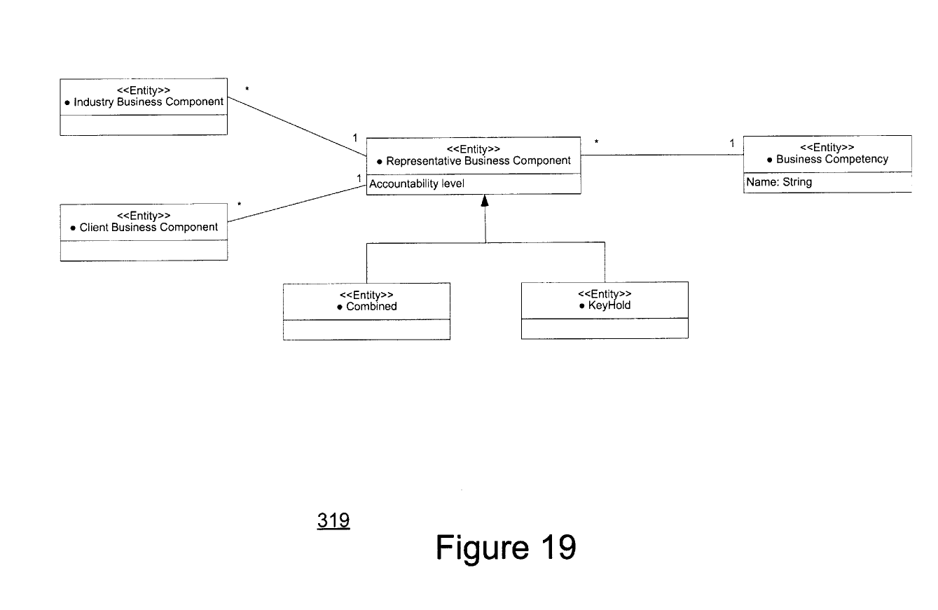

FIG. 19 is a representative business component diagram 319 that illustrates the relationship between a representative business component and between various components such as an industry business component.

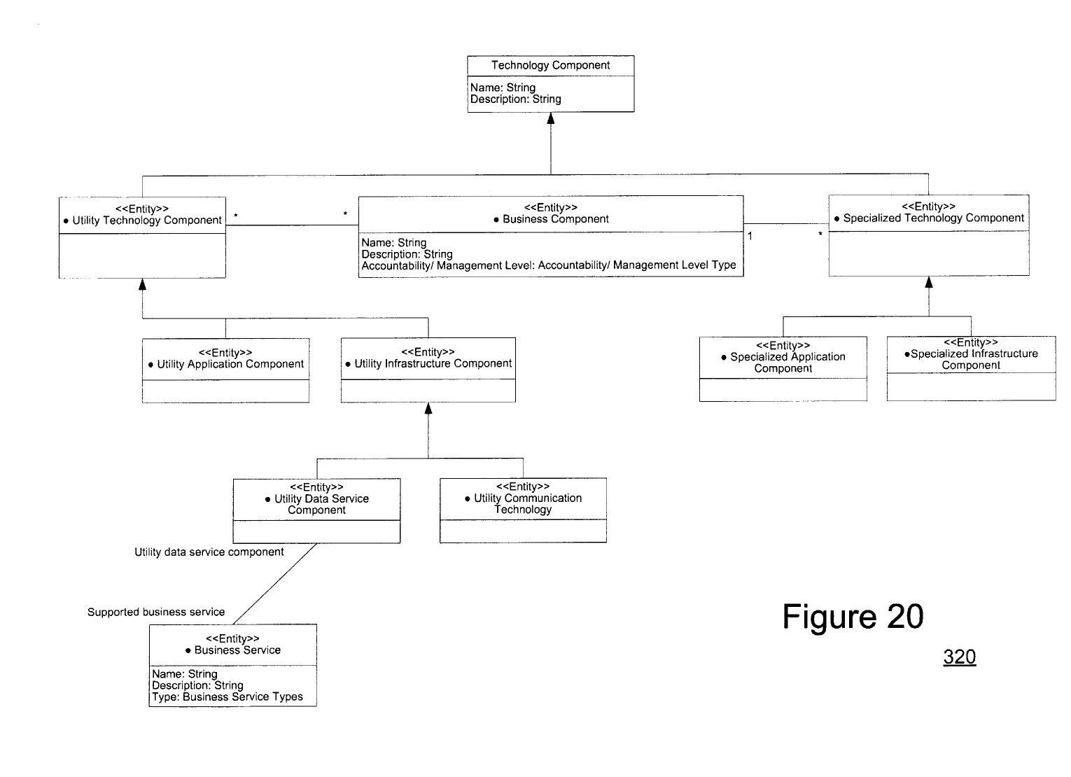

FIG. 20 is a technology component diagram 320 that illustrates the relationship between a business component and various technology components.

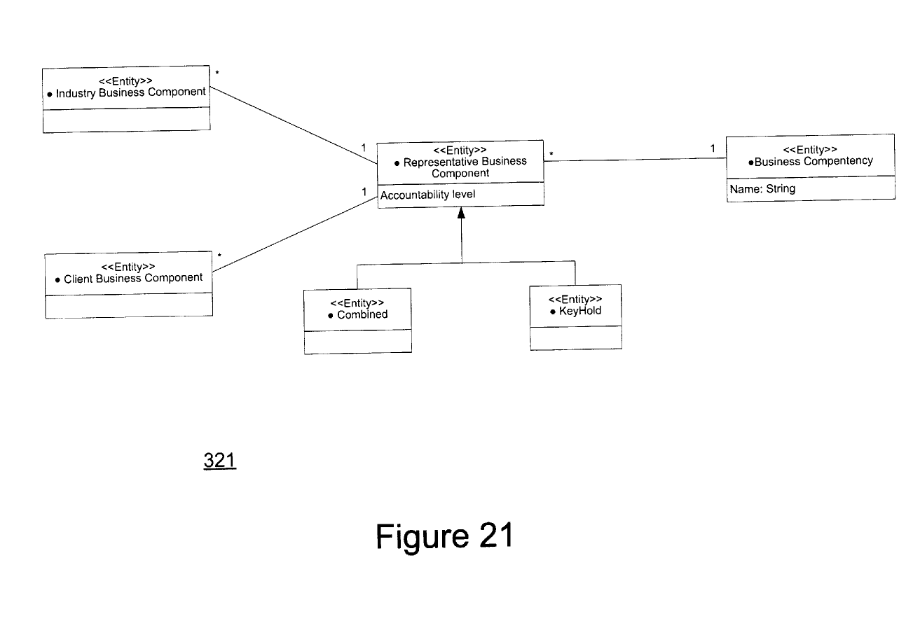

FIG. 21 is a user defined attribute diagram 321 that illustrates a framework for adding user defined attributes to any CBM entity.

Conveniently, a method for providing a service to a client is provided. The client can access the set of CBM templates over a network and utilize the set for modeling an organization. The provision of the service can include any stage of the mentioned above methods, whereas the client is connected to the set of CBM templates over a network.

Conveniently, the method for providing a service to a client includes at least the following stages: defining a set of component business modeling (CBM) templates, each comprising multiple components, wherein the set of CBM templates comprises at least one first level CBM template, multiple second level CBM templates and multiple third level CBM templates; receiving, over a network, a request to generate a CBM representation of a certain business; and allowing a user to access, over the network, the set of CBM templates and to utilize at least one CBM template to provide the CBM representation of the certain business.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the following claims.

We claim:

1. A method for modeling an organization, the method comprises:
defining a set of component business modeling (CBM) templates, each comprising multiple components, wherein the set of CBM templates comprises at least one first level CBM template, multiple second level CBM templates and multiple third level CBM templates;
receiving a request to generate a CBM representation of a certain business; and
allowing a user to utilize at least one CBM template to provide the CBM representation of the certain business.

2. The method according to claim 1 wherein the allowing comprises:
allowing a user to select a CBM template out of the set of CBM templates; and
allowing a user to selectively define business components of the selected CBM template such as to provide the CBM representation of the certain business.

3. The method according to claim 1 wherein the allowing comprises presenting to a user business components out of multiple business components that belong to the set of multiple CBM templates.

4. The method according to claim 3 wherein the allowing comprises presenting to a user multiple business components that belong to the set of CBM templates and modifying at least one business components in response to modification information provided to the user.

5. The method according to claim 1 wherein the defining comprises defining at least one component relationship between at least one business component and at least one other business component.

6. The method according to claim 5 wherein the method comprises:
receiving information selecting a business component; and
if the selected business component is associated by a relationship to another business component, providing the user an indication about the relationship.

7. The method according to claim 1 wherein a defining of a business component comprises defining at least one business component entity that belongs to the business entity.

8. The method according to claim 7 wherein the defining comprises indexing multiple business components that belong to the set of CBM templates by at least one type of business component entities.

9. The method according to claim 8 wherein the at least one type of business entities comprises a resource required form providing the business component.

10. The method according to claim 8 wherein the at least one type of business entities comprises a service provided by the business component.

11. The method according to claim 1 wherein the first level CBM template represents a group of businesses and a second level CBM template represents a sub-group of the group of businesses.

12. The method according to claim 1 wherein the utilizing comprises searching for at least one business component that belongs to a second level CBM template that represents a first sub-group of businesses that comprises the certain business.

13. The method according to claim 1 wherein the utilizing comprises searching for at least one component that belongs to a second level CBM template that represents a second sub-group of businesses that is associated with a first sub-group of business that comprises the certain business.

14. The method according to claim 1 further comprising generating a new second level CBM template if the certain business does not belong to any sub-group of classes represented by second level CBM templates.

15. The method according to claim 1 wherein the first level CBM template is a global CBM template while a second level CBM template is an industry CBM template or a sub-industry CBM template.

16. A computer program product comprising a computer usable medium including a computer readable program, wherein the computer readable program when executed on a computer causes the computer to: defining a set of component business modeling (CBM) templates, each comprising multiple components, wherein the set of CBM templates comprises at least one first level CBM template, multiple second level CBM templates and multiple third level CBM templates; receive a request to generate a CBM representation of a certain business; and allow a user to utilize at least one CBM template to provide the CBM representation of the certain business.

17. The computer program product according to claim 16, wherein the computer readable program when executed on a computer causes the computer to: allow a user to select a CBM template out of the set of CBM templates; and allow a user to selectively define business components of the selected CBM template such as to provide the CBM representation of the certain business.

18. The computer program product according to claim 16, wherein the computer readable program when executed on a computer causes the computer to present to a user business components out of multiple business components that belong to the set of multiple CBM templates.

19. The computer program product according to claim 18, wherein the computer readable program when executed on a computer causes the computer to present to a user multiple business components that belong to the set of CBM templates and modify at least one business components in response to modification information provided to the user.

20. The computer program product according to claim 16, wherein the computer readable program when executed on a computer causes the computer to define at least one component relationship between at least one business component and at least one other business component.

21. The computer program product according to claim 20, wherein the computer readable program when executed on a computer causes the computer to: receive information selecting a business component; and if the selected business component is associated by a relationship to another business component, to provide the user an indication about the relationship.

22. The computer program product according to claim 16, wherein the computer readable program when executed on a computer causes the computer to define at least one business component entity that belongs to the business entity.

23. The computer program product according to claim 22, wherein the computer readable program when executed on a computer causes the computer to index multiple business components that belong to the set of CBM templates by at least one type of business component entities.

24. The computer program product according to claim 23, wherein the computer readable program when executed on a computer causes the computer to index multiple business components that belong to the set of CBM templates by a resource required form providing the business component.

25. The computer program product according to claim 23, wherein the computer readable program when executed on a computer causes the computer to index multiple business components that belong to the set of CBM templates by a service provided by the business component.

26. The computer program product according to claim 16, wherein the first level CBM template represents a group of businesses and a second level CBM template represents a sub-group of the group of businesses.

27. The computer program product according to claim 16, wherein the computer readable program when executed on a computer causes the computer to search for at least one business component that belongs to a second level CBM template that represents a first sub-group of businesses that comprises the certain business.

28. The computer program product according to claim 16, wherein the computer readable program when executed on a computer causes the computer to search for at least one component that belongs to a second level CBM template that represents a second sub-group of businesses that is associated with a first sub-group of business that comprises the certain business.

29. The computer program product according to claim 16, wherein the computer readable program when executed on a computer causes the computer to generate a new second level CBM template if the certain business does not belong to any sub-group of classes represented by second level CBM templates.

30. The computer program product according to claim 16, wherein the first level CBM template is a global CBM template while a second level CBM template is an industry CBM template or a sub-industry CBM template.

31. A method for providing a service to a client, the method comprises: defining a set of component business modeling (CBM) templates, each comprising multiple components, wherein the set of CBM templates comprises at least one first level CBM template, multiple second level CBM templates and multiple third level CBM templates; receiving, over a network, a request to generate a CBM representation of a certain business; and allowing a user to access, over the network, the set of CBM templates and to utilize at least one CBM template to provide the CBM representation of the certain business.

32. The method according to claim 31 wherein the allowing comprises presenting to a user business components out of multiple business components that belong to the set of multiple CBM templates.

33. The method according to claim 32 wherein the allowing comprises presenting to a user multiple business components that belong to the set of CBM templates and modifying at least one business components in response to modification information provided to the user.

34. The method according to claim 31 comprising presenting to a user business components out of multiple business components that belong to the set of multiple CBM templates.

35. The method according to claim 34 comprising presenting to a user multiple business components that belong to the set of CBM templates and modifying at least one business components in response to modification information provided to the user.
